(19) United States
(12) Patent Application Publication
(10) Pub. No.: US 2020/0081898 A1
(43) Pub. Date: Mar. 12, 2020

(54) A Method for Constructing Electricity Transaction Index System Based on Big Data Technology

(71) Applicants: BEIJING KEDONG POWER CONTROL SYSTEM CO LTD, Beijing (CN); NARI GROUP CORPORATION, Nanjing (CN); STATE GRID CORPORATION OF CHINA, Beijing (CN)

(72) Inventors: HAINING WANG, Beijing (CN); LIN CHENG, Beijing (CN); YONGHUI LIU, Beijing (CN); SHUHONG SHI, Beijing (CN); XIAN ZHANG, Beijing (CN); CHUNCHENG GAO, Beijing (CN); YIN FANG, Beijing (CN); YONG DAI, Beijing (CN); LI TAO, Beijing (CN); MINGZHU YUAN, Beijing (CN); LEI WANG, Beijing (CN); TAO WANG, Beijing (CN); JIE LIU, Beijing (CN); XIAN ZHAO, Beijing (CN); XIANG TAN, Beijing (CN); NING YANG, Beijing (CN); SHOUBAO LI, Beijing (CN); PEIYU XI, Beijing (CN); QIAN ZHANG, Beijing (CN); CHUNYAN WANG, Beijing (CN); DONG LIU, Beijing (CN); WUJUN DONG, Beijing (CN); WENTAO LV, Beijing (CN); SHULU WAN, Beijing (CN); WEI WANG, Beijing (CN); XIAOPENG YUAN, Beijing (CN); JUNLIANG LV, Beijing (CN); LIN ZHANG, Beijing (CN); XIN CHANG, Beijing (CN); YUJIAN WU, Beijing (CN)

(21) Appl. No.: 15/744,912

(22) PCT Filed: Dec. 22, 2017
(86) PCT No.: PCT/CN2017/117910

§ 371 Date: Jan. 15, 2018

(30) Foreign Application Priority Data
Nov. 22, 2017 (CN) 201711169784.0

(51) Int. Cl. G06F 16/25; G06F 16/28; G06F 16/215

(52) U.S. Cl. CPC G06F 16/252; G06F 16/215; G06F 16/283; G06F 16/254

(57) ABSTRACT

The invention involves the field of power trading and especially involves a method for construction of power trading index system based on big data technology. Main steps are as follows: 1. data acquisition; 2. construction of index system: construction of index system is mainly based on cloud focus evaluation method to solve the problem of variables transformation and make data analysis through high concurrency distributed computing power of Spark memory access; 3. index calculation: adopt objective weighting approach to determine the weight of each index after index configuration and then adopt cloud focus evaluation method to calculate the weighted deviation of each index; store final evaluation result of each index into HDFS database after Spark calculation; 4. index display.

This application is the U.S. national phase of International Application No. PCT/CN2017/117910 filed on 22 Dec. 2017 which designated the U.S. and claims priority to Chinese Application No. CN201711169784.0 filed on 22 Nov. 2017, the entire contents of each of which are hereby incorporated by reference.

### FIELD OF TECHNOLOGY

The invention is aimed at summarize national unified power trading data into overall indexes and then show core indexes. Technology mainly involves big data application related technology and cloud focus evaluation method.

### BACKGROUND TECHNOLOGY

National unified power market trading platform is able to realize market functions including generation rights trade and direct trade among power users and possesses the capacity of multi-species and multi-cycle trading in parallel, which is of great practical significance to the improvement of power trading operation level and promotion of optimal allocation of power resource. At present, national power trading market members are growing continuously, trading volume rises steadily, and a large number of small and medium power uses enter the market, urgently hoping that they have access to power market information and service from internet conveniently at any time.

“Internet +” is the new format of internet development under innovation 2.0 and the new form of internet form evolution and its derived socio-economic development under the impetus of intellectual social innovation 2.0. Based on data acquisition, storage, transmission and processing technologies and corresponding infrastructure of power trading system, the establishment of corresponding index system of power trading data system can effectively reflect the conditions of power selling unit in all respects and show the whole situation of power trading market.

Contents of the Invention

Regarding problems in background technology, the invention is aimed at providing a method for construction of power trading index system based on big data technology.

In order to achieve the above objective, the invention proposes the following technical scheme.

The characteristic of a method for construction of power trading index system based on big data technology is that the method described includes the following steps.

1. Data acquisition: get essential data from through power trading system database or other unstructured database and store data on HDFS database of Hadoop cluster to support the next calculation after data cleaning;

2. Construction of index system: construction of index system is mainly based on cloud focus evaluation method to solve the problem of variables transformation and make data analysis through high concurrency distributed computing power of Spark memory access;

3. Index calculation: adopt objective weighting approach to determine the weight of each index after index configuration and then adopt cloud focus evaluation method to calculate the weighted deviation of each index; store final evaluation result of each index into HDFS database after Spark calculation;

4. Index display: get corresponding data out from HDFS according index required by application layer and display data on front-end interface through a series of interface display processing or index data combination.

Further, step 2 includes the following steps.

2.1 Establish index system

Set index system asC and C={C₁, C₂, C₃, . . . , Cₘ}.Cᵢ={Cᵢ₁,Cᵢ₂,Cᵢ₃, . . . . , Cᵢₙ}(i=1,2, . . . , m) and Cᵢⱼ represents No.j (j=1,2, . . . , n) second-class index in No.i first-class index and so on. In this way, index system with multiple layers is established.

2.2 Determine index weight

2.3 Cloud model representation of index evaluation set: set corresponding number field of evaluation set as [0,1]; each evaluation in the set is corresponding to change interval in the number field; suppose evaluation set V={very bad, bad, average, good, better, very good, excellent} and set corresponding range of evaluation P={(,0.15], (0.15,0.3], (0.3,0.45], (0.45,0.6], (0.6,0.75], (0.75,0.9], (0.9,1]}. In this way, specific data can be converted into evaluation values.

Further in step 2.2, subjective weighting approach or objective weighting approach is adopted to determine index weight;

Subjective weighting approach mentioned is that choice is made according to experience-based judgment and it includes analytic hierarchy process and Delphi method;

Objective weighting approach mentioned is that weight determination does not get affected by subjective factors but weighted value is obtained through analysis on actual data.

According to big data technology based power trading index system constructed through the above mentioned approaches, the characteristics are as follows.

Power trading index system mentioned includes data acquisition layer, data analysis layer and application display layer;

Data acquisition layer mentioned is mainly for data collection through various channels and data storage in distributed database;

Data analysis layer is mainly for construction of index system. Spark is utilized to summarize data into index data through configuration index computing rule and store data in distributed database;

Application display layer is mainly for generation of indexes constructed in data analysis into visual interfaces including statements and diagrams.

Further, distributed database mentioned is HDFS of Hadoop.

Compared with available technology, the invention has the beneficial effect that individual index is concentrated expression of absolute number, relative number or average number of a certain thing (or under a certain condition) while constructed index system as a synthetic system composed by a series of interrelated indexes can effectively reflect the conditions of research object in all respects according to the object being researched.

### DESCRIPTION OF FIGURES

FIG. 1 is diagram of index system constructed based on big data technology.

FIG. 2 is Spark calculation flow diagram of power trading

### SPECIFIC IMPLEMENTATION MODES

Specific implementation scheme of the invention is elaborated below in detail by combination of figures and specific implementation modes. These specific implementation modes are for account only but not for restricting the scope or implementation principle of the invention. Protective scope of the invention is still subject to claims. Obvious change or variation made on the base is included.

The invention is aimed at proposing key index set of power market with characteristics in multiple dimensions including market structure, market behavior and market efficiency through establishment of index system for power trading system under big data.

In order to achieve the above objective, technical solution of the invention is as follows.

I. General Introduction of the System

Technical structure of the invention is divided into data acquisition layer, data analysis layer and application display layer. Data acquisition layer mentioned is mainly for data collection through various channels and data storage in distributed database (such as HDFS of Hadoop). Data analysis layer is mainly for construction of index system. Spark is utilized to summarize data into index data through configuration index computing rule and store data in distributed database (such as HDFS of Hadoop). Application display layer is mainly for generation of indexes constructed in data analysis into visual interfaces including statements and diagrams.

The structure system can let developers only pay attention to a certain layer in the entire structure and the structure is more explicit. At the stage of later maintenance, it is easy to replace implementation of original layer with new implementation to greatly reduce maintenance cost and maintenance time.

II. Data Acquisition

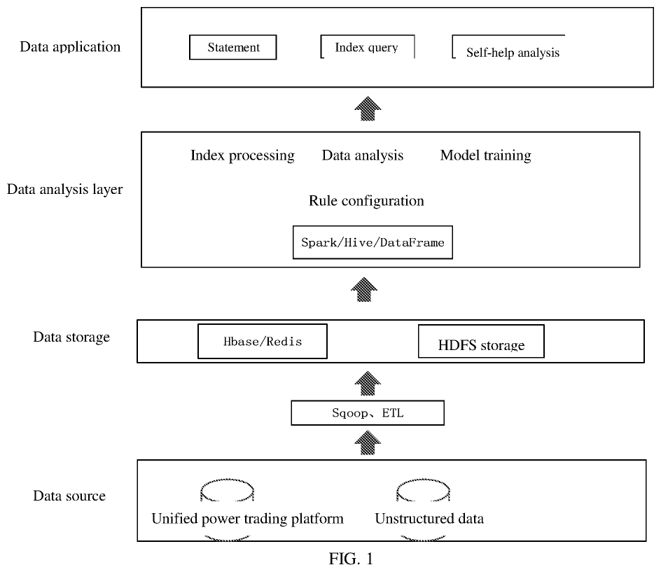

Overall structure is shown in FIG. 1. Get essential data from through power trading system database or other unstructured database and store data on HDFS database of Hadoop cluster to support the next calculation after data cleaning.

III. Construction of Index System

Construction of index system is mainly based on cloud focus evaluation method to solve the problem of variables transformation and make data analysis through high concurrency distributed computing power of Spark memory access.

(1) Establish index system. Set index system as C.

C={C₁, C₂, C₃, . . . , Cₘ}.Cᵢ={Cᵢ₁, Cᵢ₂, Cᵢ₃, . . . , Cᵢₙ}(i=1, 2, . . . , m) and Cᵢⱼ represents No.j (j=1, 2, . . . , n) second-class index in No.i first-class index and so on. In this way, index system with multiple layers is established.

(2) Determine index weight. There are many methods for determining index weight and subjective weighting approach and objective weighting approach are included. Subjective weighting approach is that choice is made according to experience-based judgment and it includes analytic hierarchy process and Delphi method. Objective weighting approach is that weight determination does not get affected by subjective factors but weighted value is obtained through analysis on actual data. The invention adopts objective weighting approach to determine the weight of each index.

(3) Cloud model representation of index evaluation set. Set corresponding number field of evaluation set as [0,1]; each evaluation in the set is corresponding to change interval in the number field; suppose evaluation set V={very bad, bad, average, good, better, very good, excellent} and set corresponding range of evaluation P={(,0.15], (0.15,0.3], (0.3,0.45], (0.45,0.6], (0.6,0.75], (0.75,0.9], (0.9,1]}. In this way, specific data can be converted into evaluation values.

IV. Index Calculation

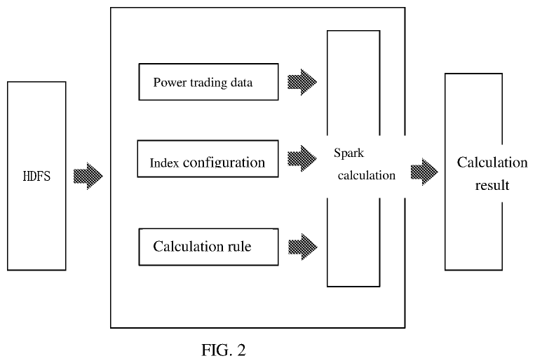

It is shown in FIG. 2. Adopt objective weighting approach to determine the weight of each index after index configuration and then adopt cloud focus evaluation method to calculate the weighted deviation of each index; store final evaluation result of each index into HDFS database after Spark calculation;

V. Index display. Get corresponding data out from HDFS according index required by application layer and display data on front-end interface through a series of interface display processing or index data combination.

What is claimed is:

1. A method for construction of power trading index system based on big data technology comprising the following steps:
1) data acquisition: get essential data from through power trading system database or other unstructured database and store data on HDFS database of Hadoop cluster to support the next calculation after data cleaning;
2) construction of index system: construction of index system is mainly based on cloud focus evaluation method to solve the problem of variables transformation and make data analysis through high concurrency distributed computing power of Spark memory access;
3) index calculation: adopt objective weighting approach to determine the weight of each index after index configuration and then adopt cloud focus evaluation method to calculate the weighted deviation of each index; store final evaluation result of each index into HDFS database after Spark calculation;
4) index display: get corresponding data out from HDFS according index required by application layer and display data on front-end interface through a series of interface display processing or index data combination.

2. The method according to claim 1, wherein
step 2) includes the following steps:
2.1) establish index system
set index system as C and C={C₁, C₂, C₃, . . . , Cₘ}.Cᵢ={Cᵢ₁,Cᵢ₂,Cᵢ₃, . . . . , Cᵢₙ}(i=1,2, . . . , m) and Cᵢⱼ represents No.j (j=1, 2, . . . , n) second-class index in No.i first-class index and so on. In this way, index system with multiple layers is established;
2.2) determine index weight;
2.3) cloud model representation of index evaluation set: set corresponding number field of evaluation set as [0,1]; each evaluation in the set is corresponding to change interval in the number field; suppose evaluation set V={very bad, bad, average, good, better, very good, excellent} and set corresponding range of evaluation P={(,0.15], (0.15,0.3], (0.3,0.45], (0.45,0.6], (0.6,0.75], (0.75,0.9], (0.9,1]}; in this way, specific data can be converted into evaluation values.

3. The method according to claim 2, wherein
in step 2.2), subjective weighting approach or objective weighting approach is adopted to determine index weight;
subjective weighting approach mentioned is that choice is made according to experience-based judgment and it includes analytic hierarchy process and Delphi method;
objective weighting approach mentioned is that weight determination does not get affected by subjective factors but weighted value is obtained through analysis on actual data.

4. The method according to claim 1, wherein
power trading index system mentioned includes data acquisition layer, data analysis layer and application display layer;
data acquisition layer mentioned is mainly for data collection through various channels and data storage in distributed database;
data analysis layer is mainly for construction of index system. Spark is utilized to summarize data into index data through configuration index computing rule and store data in distributed database;
application display layer is mainly for generation of indexes constructed in data analysis into visual interfaces including statements and diagrams.

5. The method according to claim 4, wherein the distributed database is HDFS of Hadoop.
